(19) United States
(12) Patent Application Publication
(10) Pub. No.: US 2019/0058852 A1
(43) Pub. Date: Feb. 21, 2019

(54) SYSTEM AND A METHOD FOR BROADCASTING LIVE CONTENT TO SPECTATORS' PORTABLE DEVICES AT A VENUE

(71) Applicants: Maruthi Viswanathan, Bangalore (IN); RxPrism Health Systems Private Limited, Bangalore (IN)

(72) Inventor: Maruthi Viswanathan, Bangalore (IN)

(21) Appl. No.: 16/169,670

(22) Filed: Oct. 24, 2018

(30) Foreign Application Priority Data
May 15, 2018 (IN) 201841018231

(51) Int. Cl. H04N 7/18; H04N 21/2187; H04N 21/214; H04N 21/258; H04N 21/2543

(52) U.S. Cl. CPC H04N 7/181; H04N 21/2187; H04N 21/2543; H04N 21/25825; H04N 21/2143

(57) ABSTRACT

A system and a method for broadcasting live content to spectators' portable devices at a venue is provided. The system and method facilitates a plurality of spectators to watch live performance at a venue on their personal portable devices at various angles/view in addition to their location at the venue. The live performance is captured by the plurality of capturing means and a plurality of live content is generated by the capturing means. Further, the plurality of live content is processed by a plurality of processing means in specific resolution and format. The processed plurality of live content is provided to a plurality of broadcasting units. Thereafter, the plurality of broadcasting units broadcast the plurality of live content to plurality of spectators' portable device by using a plurality of local servers and a plurality of devices.

### CROSS REFERENCE TO RELATED APPLICATIONS

This application claims priority under 35 U.S.C. § 119 to Indian Patent Application No. 201841018231, filed May 15, 2018, the contents of which are incorporated by reference herein.

### FIELD OF THE INVENTION

The present invention relates to live content broadcasting technologies and more particularly to a system and a method for providing a plurality of live content to a plurality of spectators' portable devices at a venue.

### BACKGROUND OF THE INVENTION

Enhancing experience of spectators at a venue such as stadium, auditorium, arena etc. is becoming very important in view of fast changing technologies and availability of live performance on television and/or other display devices in real time. In this regard, large televisions or large format display are installed at the venues which plays specific live game, however all spectators sitting in the venue may not be able to view the television content played in large televisions due to their sitting at the venue. Also, spectators watching live performance miss a chance to view the performance in various angles or various views/replays as how regular live telecast channel offers to people who watch from home or other places. Further, installation of such large televisions or large format displays will be a tedious and very expensive process. Further, maintenance of such large equipment is very complex and time consuming.

There have been solutions provided to aforesaid problems and few of them are discussed herein below:

U.S. Pat. No. 7,657,920 talks about a handheld electronic device for use at a venue hosting a live sporting event, having a receiver for receiving a wireless RF transmission conveying a plurality of video streams derived from video cameras filming the live sporting event, a display and a user interface for selecting a video stream among the plurality of video streams to be displayed on the display. The handheld electronic device is capable to acquire a locked mode of operation and an unlocked mode of operation, in the locked mode of operation the handheld electronic device being precluded from displaying the video streams to a spectator, in the unlocked mode of operation the handheld electronic device being enabled to display the video streams to the spectator, the handheld electronic device capable to acquire the unlocked mode of operation in response to reception of authentication data wirelessly transmitted to the handheld electronic device.

U.S. Pat. No. 8,599,253 discloses a method of providing photographic images of live events to a spectator includes obtaining at least one photographic image from at least one camera at a live event; providing a version of the at least one photographic image to an electronic device being used by the spectator; and receiving a selection of the photographic image or a portion of the photographic image selected by said spectator using the electronic device.

Though the aforesaid documents and other existing methods/systems strive to provide solutions to the problem discussed above however they still have number of shortcomings and limitations such as, unable to display live performance on the personal portable devices of the spectators in accordance with their preference, unable to provide options to the spectators to view the live performance at various angles/views in addition to their respective location at the venue and fail to explain watching live television channel on the spectators' personal portable devices.

Hence, there exists a need for a system and method that enable spectators to view the live performance on their personal portable devices in accordance with their preference. Further, reducing the expense incurred on installation and maintenance of large televisions or large format display. Also, eliminate the need to invest and provide custom portable electronic device which is very expensive too.

Any discussion of the background art throughout the specification should in no way be considered as an admission that such background art is prior art nor that such background art is widely known or forms part of the common general knowledge in the field worldwide.

### SUMMARY OF THE INVENTION

Embodiments of the present invention aim to provide a system and a method for providing a plurality of live content to a plurality of spectators' portable devices at a venue. The invention enables spectators at the venue to watch live performance at various angles/various views/replays using their personal portable devices such as smartphones as per their preference. Further, the invention facilitates spectators to select and view a goal post camera view or spider camera view as they prefer in additional to watching live performance from where they are seated.

In accordance with an embodiment of the present invention, a system for providing a plurality of live content to a plurality of spectators' portable devices at a venue is provided. The system comprising a plurality of capturing means configured to capture a live performance and generate the plurality of live content, a plurality of processing units configured to receive the plurality of live content from the plurality of capturing means and process the plurality of live content in real time, a plurality of broadcasting units configured to establish a plurality of local servers to connect a plurality of spectators' portable devices at the venue, a plurality of server load balancers configured to balance load of the plurality of local servers, a plurality of devices configured to establish a Wi-Fi network or Wi-Fi mesh network to connect the plurality of spectators' portable devices at the venue and form a wireless intranet network, a plurality of internet modules configured to connect the system to internet. The plurality of processing units further configured to provide processed plurality of live content in different resolutions and formats to the plurality of broadcasting units in real time and the plurality of broadcasting units configured to broadcast plurality of live content as plurality of live stream links concurrently to plurality of spectators' portable devices using the wireless intranet network.

The plurality of spectators' portable devices is spectators' personal, but not limited to, mobile, laptop, tablet etc.

The live performance is a, but not limited to, sports, game, match, concert, show, event, group activities etc.

In accordance with an embodiment of the present invention, the plurality of live content is, but not limited to, live performance content, live television content from large display units, large format displays, large projector screens used in the venue. Further, the plurality of live content is digital or analogue signal, audio or video or video with audio.

In accordance with an embodiment of the present invention, the venue is, but not limited to, a stadium, auditorium, arena, place for gathering large number of spectators.

In accordance with an embodiment of the present invention, the spectators are, but not limited to, a group of people and/or an individual watching a live, but not limited to, game, sport, show, performance, event.

In accordance with an embodiment of the present invention, the plurality of capturing means is, but not limited to, a camera sources at the venue. Further, the camera source is fixed or movable source.

In accordance with an embodiment of the present invention, the camera source is, but not limited to, player camera view, umpire camera view, spider camera view, drone camera view, performer camera view, goal post camera view, stump camera view, view of a camera attached to any object or human.

In accordance with an embodiment of the present invention, the plurality of capturing means is, but not limited to, live video or audio editing sources.

In accordance with an embodiment of the present invention, the plurality of capturing means is, but not limited to, live television channel sources from set-top box, large display units, large format displays, larger projector screens used in the venue.

In accordance with an embodiment of the present invention, the formats are transcoded and encoded formats.

In accordance with an embodiment of the present invention, the plurality of local servers are streaming servers, web servers, media servers, networking servers, DHCP servers, and local domain name server.

In accordance with an embodiment of the present invention, the plurality of local servers further configured to have local domain name for connected plurality of spectators' portable devices to access the local servers through browser.

In accordance with an embodiment of the present invention, the plurality of devices is configured to connect with the plurality of local servers to establish the Wi-Fi network or Wi-Fi mesh network. Further, the plurality of devices is, but not limited to, networking device, data communication device etc.

In accordance with an embodiment of the present invention, the plurality of devices is configured to connect with the plurality of local servers to establish plurality of Wi-Fi access points throughout the venue to form the wireless intranet network. Further, the plurality of devices is, but not limited to, Wi-Fi router, Wi-Fi access points, Wireless mesh router, Wi-Fi mesh network devices, Wi-Fi extenders, Gateways and switches.

In accordance with an embodiment of the present invention, the plurality of devices is configured to share SSID with or without access code to connect the plurality of spectators' portable devices through the established Wi-Fi network or Wi-Fi mesh network.

In accordance with an embodiment of the present invention, the plurality of local servers further configured to establish a captive portal for connecting the plurality of spectators' portable devices to receive and render the plurality of live stream links automatically after selecting the established Wi-Fi network or Wi-Fi mesh network. Further, the plurality of local servers comprising plurality of client web pages with user interface having inbuilt media players compatible to render the broadcasted plurality of live stream links in the connected plurality of spectators' portable devices through captive portal or browsers or custom client application.

In accordance with an embodiment of the present invention, the plurality of local servers further configured to provide different plurality of live streaming links for the each of plurality of live content provided by capturing means. Further, the plurality of connected spectators' portable devices enabled to receive different user interface options to change and render different streaming links from any of the plurality of live content provided by capturing means.

In accordance with an embodiment of the present invention, the wireless intranet network is an intranet or Wi-Fi network or Wi-Fi mesh network or WLAN or LAN with or without internet.

In accordance with an embodiment of the present invention, the plurality of live stream links comprises of video only, video and audio, audio only.

In accordance with an embodiment of the present invention, the plurality of internet modules is configured to connect with plurality of internet access point and further configured to establish internet access to the system and enable communication to cloud applications to manage subscriptions or licenses, enable communication to plurality of cloud applications for authorizing the plurality of spectators' portable devices to view plurality of live content from other plurality of capturing means that is considered to be pay per view or paid or authorized view only or authorized through external payment gateway system and to provide internet to the connected plurality of spectators' portable devices.

In accordance with an embodiment of the present invention, a method for providing a plurality of live content to a plurality of spectators' portable devices at a venue is provided. The method comprising the steps of capturing a live performance by a plurality of capturing means and generating the plurality of live content, receiving the plurality of live content from the plurality of capturing means, processing the received plurality of live content in real-time by a plurality of processing units, establishing a plurality of local servers by a plurality of broadcasting unit and a wireless intranet network by a plurality of devices, connecting a plurality of spectators' portable devices with the established wireless intranet network, broadcasting plurality of live content as plurality of live stream links concurrently to plurality of spectators' portable devices using the wireless intranet network.

The plurality of spectators' portable devices is spectators' personal, but not limited to, mobile, laptop, tablet etc. Preferably, the spectators are, but not limited to, a group of people and/or an individual watching a live, but not limited to, game, sport, show, performance, event.

In accordance with an embodiment of the present invention, the plurality of live content is, but not limited to, live performance content, live television content from large display units, large format displays, large projector screens used in the venue. Further, the plurality of live content is digital or analogue signal, audio or video or video with audio. Preferably, the live performance is a, but not limited to, sports, game match, concert, show, event, group activities etc. and the venue is, but not limited to, a stadium, auditorium, arena, place for gathering large spectators.

In accordance with an embodiment of the present invention, the plurality of capturing means is a camera sources at the venue. Further, the camera source is fixed or movable source. Preferably, the camera source is player camera view, umpire camera view, spider camera view, drone camera view, performer camera view, goal post camera view, stump camera view, view of a camera attached to any object or human.

In accordance with an embodiment of the present invention, the plurality of capturing means is live video or audio editing sources.

In accordance with an embodiment of the present invention, the plurality of capturing means is live television channel sources from set-top box, large display units, large format displays, larger projector screens used in the venue.

In accordance with an embodiment of the present invention, the step of processing is carried out by transcoding and/or encoding processes.

In accordance with an embodiment of the present invention, the wireless intranet network is a Wi-Fi access point with or without internet. Preferably, the wireless intranet network is a Wi-Fi network or Wi-Fi mesh network.

In accordance with an embodiment of the present invention, the wireless intranet network is an intranet or WLAN or LAN with or without internet.

In accordance with an embodiment of the present invention, the plurality of live stream links comprises of video only, video and audio, audio only.

In accordance with an embodiment of the present invention, the plurality of live stream links is configured with embedded media players, the embedded media player is an inbuilt-media player to render the plurality of live stream links in the connected plurality of spectators' portable devices.

In accordance with an embodiment of the present invention, the plurality of local servers is, but not limited to, streaming servers, web servers, media servers, networking servers, DHCP servers, and local domain name server. The plurality of local servers further configured to have local domain name for connected spectators' portable devices to access the local servers through browser.

In accordance with an embodiment of the present invention, the step of establishing further comprises a step of connecting the plurality of local servers with a plurality of devices to establish a Wi-Fi network or Wi-Fi mesh network at the venue.

In accordance with an embodiment of the present invention, the plurality of devices is Wi-Fi router, Wi-Fi access points, Wireless mesh router, Wi-Fi mesh network devices, Wi-Fi extenders, Gateways and switches. Further, the plurality of devices is, but not limited to, networking device, data communication device etc.

In accordance with an embodiment of the present invention, the step of connecting further comprises a step of establishing plurality of Wi-Fi access points throughout the venue and connecting spectators' portable devices to form the wireless intranet network.

In accordance with an embodiment of the present invention, the step of connecting further comprises a step of sharing SSID with or without access code by a plurality of devices with the plurality of spectators' portable devices.

In accordance with an embodiment of the present invention, the plurality of spectators' portable devices access and renders the plurality of live stream links automatically through captive portal while connecting with the wireless intranet network.

In accordance with an embodiment of the present invention, the plurality of spectators' portable devices access and renders the plurality of live stream links through browsers by accessing system's local domain name or IP address.

In accordance with an embodiment of the present invention, the plurality of spectators' portable devices access and renders the plurality of live stream links through custom client application.

In accordance with an embodiment of the present invention, the plurality of spectators' portable devices renders all received plurality of live stream links in an embedded media player or on their default media player.

In accordance with an embodiment of the present invention, the method further comprises a step of establishing internet access, by an internet module, to a system employing the method and enabling communication to cloud applications to manage the system activation or deactivation or subscriptions or licenses.

In accordance with an embodiment of the present invention, the method further comprises a step of enabling communication, by the internet module, to plurality of cloud applications for authorizing the plurality of spectators' portable devices to view plurality of live content that is considered to be pay per view or paid or authorized view only or authorized through external payment gateway systems.

In accordance with an embodiment of the present invention, the method further comprises a step of providing internet, by the internet module, to the connected plurality of spectators' portable devices.

In accordance with an embodiment of the present invention, the plurality of connected spectators' portable devices enabled to receive different user interface options to change and render different streaming links from any of the plurality of live content provided by capturing means.

### BRIEF DESCRIPTION OF THE DRAWINGS

So that the manner in which the above recited features of the present invention can be understood in detail, a more particular description of the invention, briefly summarized above, may have been referred by embodiments, some of which are illustrated in the appended drawings. It is to be noted, however, that the appended drawings illustrate only typical embodiments of this invention and are therefore not to be considered limiting of its scope, for the invention may admit to other equally effective embodiments.

These and other features, benefits, and advantages of the present invention will become apparent by reference to the following text figure, with like reference numbers referring to like structures across the views, wherein

FIG. 1 is an exemplary system for providing a plurality of live content to a plurality of spectators' portable devices at a venue, in accordance with an embodiment of the present invention;

FIG. 2 illustrates a user interface that enables users to view live content on their portable devices, in accordance with an embodiment of the present invention;

FIG. 3 illustrates a user interface that enables users to view live content on their devices, in accordance with an embodiment of the present invention;

FIG. 4 illustrates a scenario employing the exemplary system, in accordance with an embodiment of the present invention; and

FIG. 5 is a flow chart illustrating a method for providing a plurality of live content to a plurality of spectators' portable devices at a venue, in accordance with an embodiment of the present invention.

### DETAILED DESCRIPTION OF THE DRAWINGS

The present invention is described hereinafter by various embodiments with reference to the accompanying drawing, wherein reference numerals used in the accompanying drawing correspond to the like elements throughout the description.

While the present invention is described herein by way of example using embodiments and illustrative drawings, those skilled in the art will recognize that the invention is not limited to the embodiments of drawing or drawings described, and are not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed, but on the contrary, the invention is to cover all modifications, equivalents, and alternatives falling within the scope of the present invention as defined by the appended claim. As used throughout this description, the word “may” is used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes.

Further, the various embodiments described herein below include specific method steps in an exemplary order but a wide variety of other such method steps could be implemented within the scope of the invention, including additional steps, omission of some steps, or performing the method in a different order.

The present invention aims to overcomes the drawbacks of the prior art by enabling spectators to watch a live performance at a venue at various angles/views in addition to the view based on his/her location at the venue. This prevent spectators from missing a chance to view the performance in various angles or various views/replays as how regular live telecast channel offers to people who watch from home or other places. Further, the present invention limits the huge investment incurred in installation of large television screens/displays. However, a person skilled in the art would appreciate that the invention is not limited to the exemplary environment discussed below alone and can be implemented in various other physical environments, without departing from the scope of the invention.

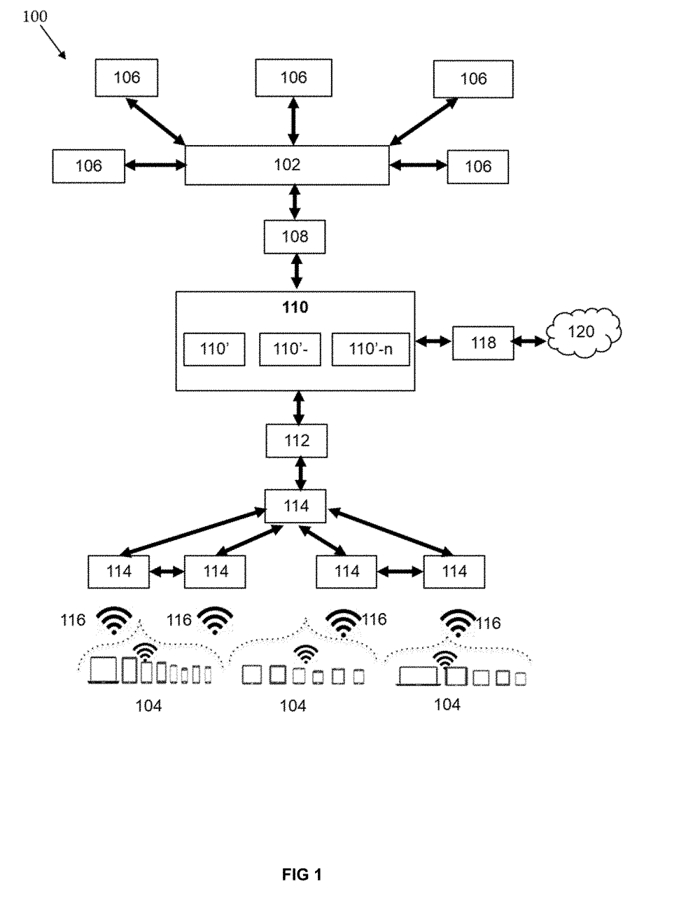

Referring to the drawings, the invention will now be described in more detail. FIG. 1 illustrates an exemplary system (100) for providing a plurality of live content (102) to a plurality of spectators' portable devices (104) at a venue. The system (100) comprises of a plurality of capturing means (106), a plurality of processing units (108), a plurality of broadcasting units (110), a plurality of server load balancers (112), a plurality of devices (114) and a plurality of internet modules (118).

The plurality of live content (102) is, but not limited to, live performance content, live television content from large display units, large format displays, large projector screens used in the venue. Further, the plurality of live content is digital or analogue signal, audio or video or video with audio.

The each of the plurality of spectators' portable devices (104) is associated with a spectator. A spectator may be an individual watching a live, but not limited to, game, sport, show, performance, event. The plurality of spectators may be a group of people watching a live, but not limited to, game, sport, show, performance, event. The plurality of spectators' portable devices (104) may be selected from a group comprising mobile handheld devices (such as mobile phones, PDA and tablet PCs etc.), desktop PCs and notebooks etc. the plurality of spectators' portable devices (104) is envisaged to be connected with one or more input devices (such as a keyboard, a camera, microphone etc.) (not shown) and one or more output devices (such as a display screen, speaker etc.) (not shown). In case of mobile handheld devices such as a smartphone, the one or more input devices and the one or more output devices may be integrally provided. For example, in touch-input based camera-enabled smartphone no external devices need to be connected.

The venue may be a stadium, auditorium, arena, place for gathering large number of spectators.

The plurality of capturing means (106) are selected from a group of, but not limited to, a camera sources at the venue, live video or audio editing sources and live television channel sources from set-top box, large display units, large format displays, larger projector screens used in the venue. Further, the camera source is fixed or movable source. Preferably, the camera source is, but not limited to, player camera view, umpire camera view, spider camera view, drone camera view, performer camera view, goal post camera view, stump camera view, view of a camera attached to any object or human.

The plurality of capturing means (106) is configured to capture a live performance and generate the live content. The live performance may be selected from a group of, but not limited to, sports, game match, concert, show, event, group activities etc.

The plurality of processing units (108) may be a portable computing device or a desktop computer or a large computing/transcoding server. The plurality of processing units (108) is envisaged to include computing capabilities such as a memory unit (not shown) configured to store machine readable instructions. The machine readable instructions may be loaded into the memory unit from a non-transitory machine readable medium such as, but not limited to, CD-ROMs, DVD-ROMs and Flash Drives. Alternately, the machine readable instructions may be loaded in a form of a computer software program into the memory unit. The memory unit in that manner may be selected from a group comprising EPROM, EEPROM and Flash memory.

Further, the plurality of processing units (108) includes a processor or plurality of high speed computing processors with multiple cores (not shown) operably connected with the memory unit. In various embodiments, the processor is one of, but not limited to, a general purpose processor, an application specific integrated circuit (ASIC) and a field-programmable gate array (FPGA). The plurality of processing units (108) is also envisaged to include signal processing capabilities. Also, The CPU and other hardware configuration of the plurality of processing units (108) will be scaled-up or scaled-down as per the deployment scale & number of live content (102) channel.

The plurality of processing units (108) is configured to receive the plurality of live content from the plurality of capturing means and process the plurality of live content in real time. The plurality of processing units (108) further configured to provide processed plurality of live content (102) in different resolutions and formats to the plurality of broadcasting units (110) in real time. Preferably, the formats are transcoded and encoded formats.

The plurality of broadcasting units (110) may be a portable computing device, a desktop computer or plurality of server stack. The plurality of broadcasting units (110) is envisaged to include computing capabilities such as a memory unit (not shown) configured to store machine readable instructions. The machine readable instructions may be loaded into the memory unit from a non-transitory machine-readable medium such as, but not limited to, CD-ROMs, DVD-ROMs and Flash Drives. Alternately, the machine readable instructions may be loaded in a form of a computer software program into the memory unit. The memory unit in that manner may be selected from a group comprising EPROM, EEPROM and Flash memory.

Further, the plurality of broadcasting units (110) includes a processor or plurality of high speed computing processors with multiple cores (not shown) operably connected with the memory unit. In various embodiments, the processor is one of, but not limited to, a general purpose processor, an application specific integrated circuit (ASIC) and a field-programmable gate array (FPGA).

The plurality of broadcasting units (110) configured to establish the plurality of local servers (110′) to connect the plurality of spectators' portable devices (104) at the venue. The plurality of local servers (110′) are part of the plurality of broadcasting units (110) therefore assigned the same reference numeral. Further, the plurality of broadcasting units configured to broadcast plurality of live content (102) as plurality of live stream links concurrently to the plurality of spectators' portable devices (104) using a wireless intranet network (116).

The plurality of local serves (110′) is selected from a group of, but not limited to, streaming servers, web servers, media servers, networking servers, DHCP servers, and local domain name server. Further, the plurality of local servers (110′) configured to have local domain name for connected plurality of spectators' portable devices (104) to access the local servers through browser. Also, load of the plurality of local servers (110′) is balanced by the plurality of server load balancers (112).

The plurality of local servers (110′) further configured to establish a captive portal for connecting the plurality of spectators' portable devices (104) to receive and render the plurality of live stream links automatically after selecting an established Wi-Fi network or Wi-Fi mesh network. Further, the plurality of local servers (110′) comprising plurality of client web pages with user interface having inbuilt media players compatible to render the broadcasted plurality of live stream links in the connected plurality of spectators' portable devices (104) through captive portal or browsers or custom client application.

Further, the plurality of local servers (110′) configured to provide different plurality of live streaming links for the each of plurality of live content (102) provided by each of the plurality of capturing means (106). Further, the plurality of connected spectators' portable devices (102) enable to receive different user interface options to change and render different streaming links from any of the plurality of live content (102) provided by the plurality of capturing means (106).

The plurality of devices (114) may be selected from a group of, but not limited to, networking devices, Wi-Fi router, Wi-Fi access points, Wireless mesh router, Wi-Fi mesh network devices, Wi-Fi extenders, Gateways and switches, data communication device, computing device, a desktop computer or plurality of server stack. The plurality of devices (114) is envisaged to include computing capabilities such as a memory unit (not shown) configured to store machine readable instructions. The machine readable instructions may be loaded into the memory unit from a non-transitory machine-readable medium such as, but not limited to, CD-ROMs, DVD-ROMs and Flash Drives. Alternately, the machine readable instructions may be loaded in a form of a computer software program into the memory unit. The memory unit in that manner may be selected from a group comprising EPROM, EEPROM and Flash memory.

Further, the plurality of devices (114) includes a processor or plurality of high speed computing processors with multiple cores (not shown) operably connected with the memory unit. In various embodiments, the processor is one of, but not limited to, a general purpose processor, an application specific integrated circuit (ASIC) and a field-programmable gate array (FPGA).

The plurality of devices (114) configured to establish a Wi-Fi network or Wi-Fi mesh network to connect the plurality of spectators' portable devices (104) at the venue and form a wireless intranet network (116). Further, the plurality of devices (114) is configured to connect with the plurality of local servers (110′) to establish the Wi-Fi network or Wi-Fi mesh network.

In accordance with an embodiment of the present invention, the plurality of devices (114) is configured to connect with the plurality of local servers (110′) to establish plurality of Wi-Fi access points throughout the venue to form the wireless intranet network (116). Further, the plurality of devices (114) is configured to share SSID with or without access code to connect the plurality of spectators' portable devices (104) through the established Wi-Fi network or Wi-Fi mesh network.

In accordance with an embodiment of the present invention, the wireless intranet network (116) is an intranet or Wi-Fi network or Wi-Fi mesh network or WLAN or LAN with or without internet.

In accordance with an embodiment of the present invention, the plurality of live stream links comprises of video only, video and audio, audio only.

The plurality of internet modules (118) is configured to connect with plurality of internet access point or internet service provider (ISP)and further configured to establish internet access to the system (100) and enable communication to cloud applications to manage subscriptions or licenses, enable communication to plurality of cloud applications for authorizing the plurality of spectators' portable devices (104) to view the plurality of live content (102) from other plurality of capturing means that is considered to be pay per view or paid or authorized view only or authorized through external payment gateway system and to provide access to internet (120) to the connected plurality of spectators' portable devices (104). Further, the plurality of internet modules (118) is connected to a data repository (not shown). The data repository may be a cloud based storage or a local storage. In any manner, the database is envisaged to be capable of providing the data to any of the computing devices connected with the internet (120), when the data is queried appropriately using applicable security and other data transfer protocols.

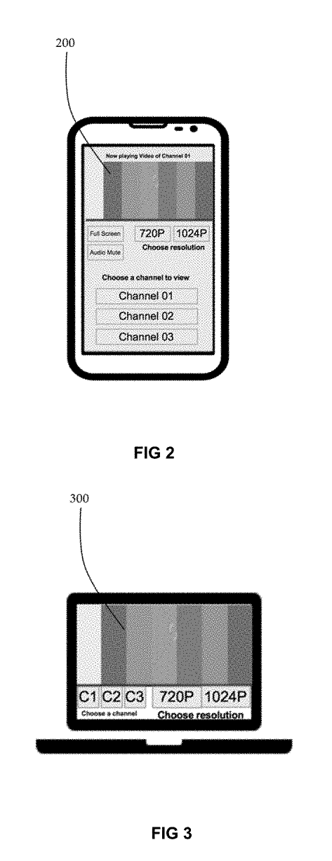

FIG. 2 illustrates a user interface (200) that enable spectators to view the plurality of live content (102) on their portable devices (104) such as mobiles, tablets etc. and provides number of options such as changing of view/channel, setting resolution of the rendered content etc. The FIG. 3 illustrates a user interface (300) that enables spectators to view the plurality of live content (102) on their devices such as desktop, laptop etc. The user interface for laptops or desktops is the same interface of the mobile device. Thus, the system and method disclosed in the present invention allow spectators at a venue to view the plurality of live content onto their personal portable devices (104) such as mobile phones, laptops and tablets at various angles/views with a multi channel or live content viewing option thereby enabling a spectator to view the plurality of live content (102) in real time in accordance with his/her preference.

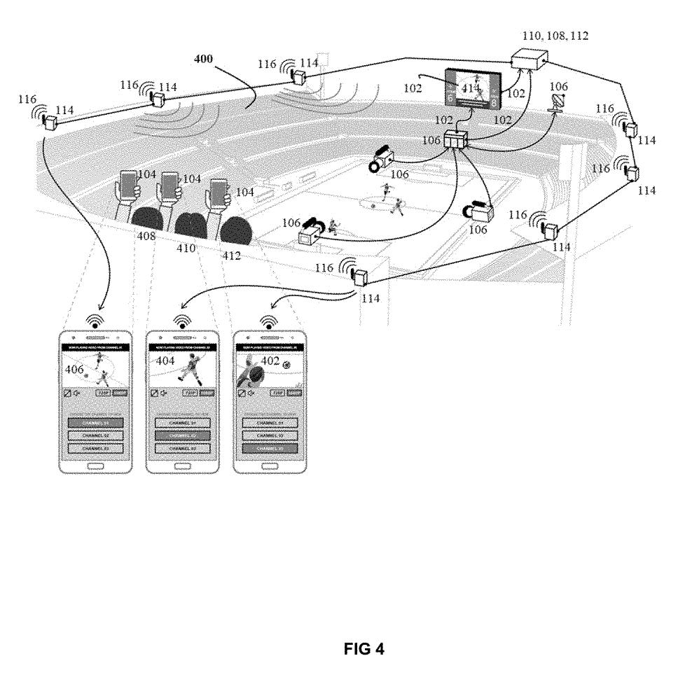

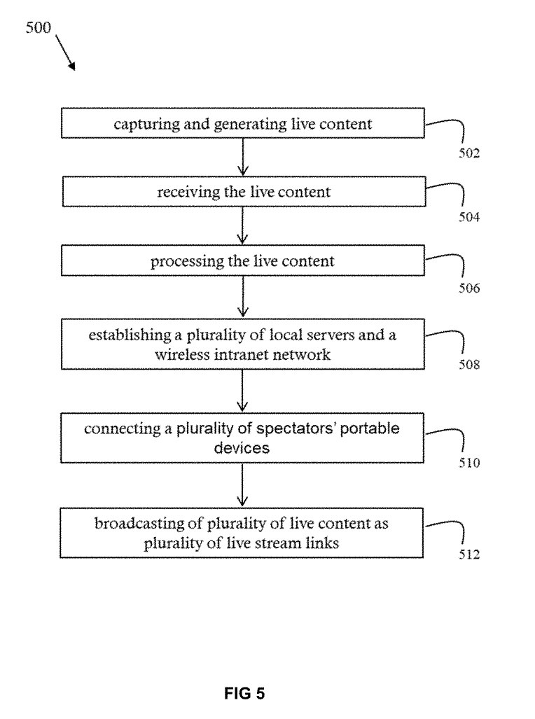

FIG. 4 illustrates a scenario employing the exemplary system (100), in accordance with an embodiment of the present invention. As shown in FIG. 4, the venue (400) is a stadium and the live performance is a soccer match. Further, at the venue (400) plurality of spectators (408, 410, 412) carrying each of their personal the plurality of spectators' portable devices (104). The plurality of capturing means (106) i.e. camera sources are deployed at the venue (400) at various angles to capture various views to capture the live performance.

The plurality of live content (102) is generated by the capturing means (106) and provided to the plurality of processing units (108). In this specific example, one of the plurality of live content (102) is live television content from large display unit (414) or live content from audio/video editing device or other capturing means. The processing units (108) processing the plurality of live content (102) and transmitting the processed plurality of live content (102) to the plurality of broadcasting units (110). Thereafter, the broadcasting unit establishes the wireless intranet network (116) by using the plurality of devices (114) and the plurality of spectators' portable devices (104) are connected with the established wireless intranet network (116). After connecting with the established wireless intranet network (116) the plurality of spectators' portable devices (104) receives concurrently broadcasted plurality of live content (102). As shown in FIG. 4, each of the plurality of spectators (408, 410, 412) can view the plurality of live content (102) in accordance with his/her preference (406, 404, 402) by using the user interface from different sources of the plurality of capturing means (106).

FIG. 5 is a flow chart illustrating a method (500) for providing a plurality of live content (102) to a plurality of spectators' portable devices (104) at a venue, in accordance with an embodiment of the present invention. The method 500 starts at step 502 when a live performance is captured by a plurality of capturing means (106) and the plurality of capturing means (106) generates the plurality of live content (102). The plurality of live content (102) is, but not limited to, live performance content, live television content from large display units, large format displays, large projector screens used in the venue. Further, the plurality of live content is digital or analogue signal, audio or video or video with audio. The live performance may be selected from a group of, but not limited to, sports, game match, concert, show, event, group activities etc. The venue may be a stadium, auditorium, arena, place for gathering large number of spectators.

The each of the plurality of spectators' portable devices (104) is associated with a spectator. A spectator may be an individual watching a live, but not limited to, game, sport, show, performance, event. The plurality of spectators may be a group of people watching a live, but not limited to, game, sport, show, performance, event. The plurality of spectators' portable devices (104) may be selected from a group comprising mobile handheld devices (such as mobile phones, PDA and tablet PCs etc.), desktop PCs and notebooks etc. the plurality of spectators' portable devices (104) is envisaged to be connected with one or more input devices (such as a keyboard, a camera, microphone etc.) (not shown) and one or more output devices (such as a display screen, speaker etc.) (not shown). In case of mobile handheld devices such as a smartphone, the one or more input devices and the one or more output devices may be integrally provided. For example, in touch-input based camera-enabled smartphone no external devices need to be connected.

The plurality of capturing means (106) are selected from a group of, but not limited to, a camera sources at the venue, live video or audio editing sources and live television channel sources from set-top box, large display units, large format displays, larger projector screens used in the venue. Further, the camera source is fixed or movable source. Preferably, the camera source is, but not limited to, player camera view, umpire camera view, spider camera view, drone camera view, performer camera view, goal post camera view, stump camera view, view of a camera attached to any object or human.

Once the plurality of live content (102) is captured and generated by the plurality of capturing means (106) then at step 504 the plurality of live content (102) is received and at step 506 the plurality of live content (102) is processed in real time by a plurality of processing units (108). Further, the step of 506 comprising of processing the plurality of live content (102) in different resolutions and formats to the plurality of broadcasting units (110) in real time. Preferably, the step of processing 506 is carried out by transcoding and/or encoding processes.

The plurality of processing units (108) may be a portable computing device or a desktop computer or a large computing/transcoding server. The plurality of processing units (108) is envisaged to include computing capabilities such as a memory unit (not shown) configured to store machine readable instructions. The machine readable instructions may be loaded into the memory unit from a non-transitory machine readable medium such as, but not limited to, CD-ROMs, DVD-ROMs and Flash Drives. Alternately, the machine readable instructions may be loaded in a form of a computer software program into the memory unit. The memory unit in that manner may be selected from a group comprising EPROM, EEPROM and Flash memory. Further, the plurality of processing units (108) includes a processor or plurality of high speed computing processors with multiple cores (not shown) operably connected with the memory unit. In various embodiments, the processor is one of, but not limited to, a general purpose processor, an application specific integrated circuit (ASIC) and a field-programmable gate array (FPGA). The plurality of processing units (108) is also envisaged to include signal processing capabilities. Also, The CPU and other hardware configuration of the plurality of processing units (108) will be scaled-up or scaled-down as per the deployment scale & number of live content (102) channel.

Once the plurality of content (102) is processed by the plurality of processing units (108) then at step 508 the plurality of broadcasting units (110) establishes a plurality of a plurality of local servers (110′). Also, the plurality of broadcasting units (110) establishes a wireless intranet network (116) by a plurality of devices (114) at step 508.

The step 508 of establishing may further comprises of a step of connecting the plurality of local servers (110′) with the plurality of devices (114) to establish a Wi-Fi network or Wi-Fi mesh network at the venue. Whereas, the step of connecting further comprises a step of establishing plurality of Wi-Fi access points throughout the venue and connecting spectators' portable devices (104) to form the wireless intranet network (116).

In accordance with an embodiment of the present invention, the wireless intranet network (116) is a Wi-Fi access point with or without internet. Preferably, the wireless intranet network (116) is a Wi-Fi network or Wi-Fi mesh network. Also, the wireless intranet network (116) is an intranet or WLAN or LAN with or without internet.

In accordance with an embodiment of the present invention, the plurality of local servers (110′) are streaming servers, web servers, media servers, networking servers, DHCP servers, and local domain name server. Further, the plurality of local servers (110′) configured to have local domain name for connected spectators' portable devices (104) to access the local servers through browser. Also, to balance the load of the plurality of local servers (110′) a plurality of server load balancers (112) are provided.

In accordance with an embodiment of the present invention, the plurality of devices (114) is Wi-Fi router, Wi-Fi access points, Wireless mesh router, Wi-Fi mesh network devices, Wi-Fi extenders, Gateways and switches.

After establishing the plurality of local servers (110′) and the wireless intranet network (116) at step 510 the plurality of spectators' portable devices (104) are connected with the established wireless intranet network (116) and at step 512 the plurality of live content (102) is broadcasted as plurality of live stream links concurrently to plurality of spectators' portable devices (104) using the wireless intranet network (116). The plurality of live stream links comprises of video only, video and audio, audio only. Further, the plurality of live stream links is configured with embedded media players, the embedded media player is an inbuilt-media player to render the plurality of live stream links in the connected plurality of spectators' portable devices (104).

The step of connection 510 may further comprises of a step of sharing SSID with or without access code by a plurality of devices (114) with the plurality of spectators' portable devices (104).

In accordance with an embodiment of the present invention, at step 512, the plurality of spectators' portable devices (104) may access and renders the plurality of live stream links automatically through captive portal while connecting with the wireless intranet network (116). Further, at step 512, the plurality of spectators' portable devices (104) may access and renders the plurality of live stream links through browsers by accessing system's local domain name or IP address. Also, at step 512, the plurality of spectators' portable devices (104) may access and renders the plurality of live stream links through custom client application. Preferably, the plurality of spectators' portable devices (104) renders all received plurality of live stream links in an embedded media player or on their default media player and the plurality of connected spectators' portable devices (104) enabled to receive different user interface options to change and render different streaming links from any of the plurality of live content (102) provided by the plurality of capturing means (106).

The method 500 may further comprising a step of establishing internet access, by an internet module (118), to a system (100) employing the method (500) and enabling communication to cloud applications to manage the system activation or deactivation or subscriptions or licenses. Further, a step of enabling communication is provided, by the internet module (118), to plurality of cloud applications for authorizing the plurality of spectators' portable devices (104) to view plurality of live content (102) that is considered to be pay per view or paid or authorized view only or authorized through external payment gateway systems. Also, a step of providing internet (120), by the internet module (118), to the connected plurality of spectators' portable devices (104) is provided,

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to be providing broadest scope of consistent with the principles and the novel and inventive features disclosed or suggested herein. Accordingly, the invention is anticipated to hold on to all other such alternatives, modifications, and variations that fall within the scope of the present invention and appended claims.

We claim:

1. A system (100) for providing a plurality of live content (102) to a plurality of spectators' portable devices (104) at a venue comprising:
a plurality of capturing means (106) configured to capture a live performance and generate the plurality of live content (102);
a plurality of processing units (108) configured to receive the plurality of live content (102) from the plurality of capturing means (106) and process the plurality of live content (102) in real time;
a plurality of broadcasting units (110) configured to establish a plurality of local servers (110′) to connect a plurality of spectators' portable devices (104) at the venue;
a plurality of server load balancers (112) configured to balance load of the plurality of local servers (110′);
a plurality of devices (114) configured to establish a Wi-Fi network or Wi-Fi mesh network to connect the plurality of spectators' portable devices (104) at the venue and form a wireless intranet network (116);
a plurality of internet modules (118) configured to connect the system to internet (120);
wherein
the plurality of processing units (108) further configured to provide processed plurality of live content (102) in different resolutions and formats to the plurality of broadcasting units (110) in real time; and
the plurality of broadcasting units (110) configured to broadcast plurality of live content (104) as plurality of live stream links concurrently to plurality of spectators' portable devices (104) using the wireless intranet network (116).

2. The system (100) as claimed in claim 1, wherein the plurality of live content (102) is live performance content, live television content from large display units, large format displays, large projector screens used in the venue.

3. The system (100) as claimed in claim 1, wherein the plurality of live content (102) is digital or analogue signal, audio or video or video with audio.

4. The system (100) as claimed in claim 1, wherein the venue is a stadium, auditorium, arena, place for gathering large spectators.

5. The system (100) as claimed in claim 1, wherein the spectators is group of people watching a game, a sport, a show, a performance, an event.

6. The system (100) as claimed in claim 1, wherein the plurality of capturing means (106) is a camera sources at the venue.

7. The system (100) as claimed in claim 6, wherein the camera source is fixed or movable source.

8. The system (100) as claimed in claim 6, wherein the camera source is player camera view, umpire camera view, spider camera view, drone camera view, performer camera view, goal post camera view, stump camera view, view of a camera attached to any object or human.

9. The system (100) as claimed in claim 1, wherein the plurality of capturing means (106) is live video or audio editing sources.

10. The system (100) as claimed in claim 1, wherein the plurality of capturing means (106) is live television channel sources from set-top box, large display units, large format displays, larger projector screens used in the venue.

11. The system (100) as claimed in claim 1, wherein the formats are transcoded and encoded formats.

12. The system (100) as claimed in claim 1, wherein the plurality of local servers (110′) are streaming servers, web servers, media servers, networking servers, DHCP servers, and local domain name server.

13. The system (100) as claimed in claim 12, wherein the plurality of local servers (110′) further configured to have local domain name for connected spectators' portable devices to access the local servers through browser.

14. The system (100) as claimed in claim 1, wherein the plurality of devices (114) is configured to connect with the plurality of local servers (110′) to establish the Wi-Fi network or Wi-Fi mesh network.

15. The system (100) as claimed in claim 14, wherein the plurality of devices (114) is Wi-Fi router, Wi-Fi access points, Wireless mesh router, Wi-Fi mesh network devices, Wi-Fi extenders, Gateways and switches.

16. The system (100) as claimed in claim 14, wherein the plurality of devices (114) is configured to connect with the plurality of local servers (110′) to establish plurality of Wi-Fi access points throughout the venue to form the wireless intranet network (116).

17. The system (100) as claimed in claim 1, wherein the plurality of devices (114) is configured to share SSID with or without access code to connect the plurality of spectators' portable devices (104) through the established Wi-Fi network or Wi-Fi mesh network.

18. The system (100) as claimed in claim 1, wherein the plurality of local servers (110′) further configured to establish a captive portal for connecting the plurality of spectators' portable devices (104) to receive and render the plurality of live stream links automatically after selecting the established Wi-Fi network or Wi-Fi mesh network.

19. The system (100) as claimed in claim 1, wherein the plurality of local servers (110′) further comprising plurality of client web pages with user interface having inbuilt media players compatible to render the broadcasted plurality of live stream links in the connected plurality of spectators' portable devices (104) through captive portal or browsers or custom client application.

20. The system (100) as claimed in claim 1, wherein the plurality of local servers (110′) further configured to provide different plurality of live streaming links for the each of plurality of live content provided by capturing means.

21. The system (100) as claimed in claim 1, wherein the plurality of connected spectators' portable devices (104) enabled to receive different user interface options to change and render different streaming links from any of the plurality of live content (102) provided by capturing means (106).

22. The system (100) as claimed in claim 1, wherein the wireless intranet network (116) is an intranet or Wi-Fi network or Wi-Fi mesh network or WLAN or LAN with or without internet.

23. The system (100) as claimed in claim 1, wherein the plurality of live stream links comprises of video only, video and audio, audio only.

24. The system (100) as claimed in claim 1, wherein the plurality of internet modules (118) is configured to connect with plurality of internet access point and further configured to:
establish internet access to the system (100) and enable communication to cloud applications to manage subscriptions or licenses;
enable communication to plurality of cloud applications for authorizing the plurality of spectators' portable devices (104) to view plurality of live content (102) from other plurality of capturing means (106) that is considered to be pay per view or paid or authorized view only or authorized through external payment gateway system; and
provide internet (120) to the connected plurality of spectators' portable devices (104).

25. A method (500) for providing a plurality of live content (102) to a plurality of spectators' portable devices (104) at a venue, the method comprising the steps of:
capturing (502) a live performance by a plurality of capturing means (106) and generating the plurality of live content (102);
receiving (504) the plurality of live content (102) from the plurality of capturing means (106);
processing (506) the received plurality of live content (102) in real time by a plurality of processing units (108);
establishing (508) a plurality of local servers (110′) by a plurality of broadcasting units (110) and a wireless intranet network (116) by a plurality of devices (114);
connecting (510) a plurality of spectators' portable devices (104) with the established wireless intranet network (116); and
broadcasting (512) plurality of live content (102) as plurality of live stream links concurrently to plurality of spectators' portable devices (104) using the wireless intranet network (116).

26. The method (500) as claimed in claim 25, wherein the plurality of live content (102) is live performance content, live television content from large display units, large format displays, large projector screens used in the venue.

27. The method (500) as claimed in claim 25, wherein the plurality of live content (102) is digital or analogue signal, audio or video or video with audio.

28. The method (500) as claimed in claim 25, wherein the venue is a stadium, auditorium, arena, place for gathering large spectators.

29. The method (500) as claimed in claim 25, wherein the spectators is group of people watching a game, a sport, a show, a performance, an event.

30. The method (500) as claimed in claim 25, wherein the plurality of capturing means (106) is a camera sources at the venue.

31. The method (500) as claimed in claim 30, wherein the camera source is fixed or movable source.

32. The method (500) as claimed in claim 30, wherein the camera source is player camera view, umpire camera view, spider camera view, drone camera view, performer camera view, goal post camera view, stump camera view, view of a camera attached to any object or human.

33. The method (500) as claimed in claim 25, wherein the plurality of capturing means (106) is live video or audio editing sources.

34. The method (500) as claimed in claim 25, wherein the plurality of capturing means (106) is live television channel sources from set-top box, large display units, large format displays, larger projector screens used in the venue.

35. The method (500) as claimed in claim 25, wherein the step of processing (506) is carried out by transcoding and/or encoding processes.

36. The method (500) as claimed in claim 25, wherein the wireless intranet network (116) is a Wi-Fi access point with or without internet.

37. The method (500) as claimed in claim 25, wherein the wireless intranet network (116) is a Wi-Fi network or Wi-Fi mesh network.

38. The method (500) as claimed in claim 25, wherein the wireless intranet network (116) is an intranet or WLAN or LAN with or without internet.

39. The method (500) as claimed in claim 25, wherein the plurality of live stream links comprises of video only, video and audio, audio only.

40. The method (500) as claimed in claim 25, wherein the plurality of live stream links is configured with embedded media players, the embedded media player is an inbuilt-media player to render the plurality of live stream links in the connected plurality of spectators' portable devices (104).

41. The method (500) as claimed in claim 25, wherein the plurality of local servers (110′) are streaming servers, web servers, media servers, networking servers, DHCP servers, and local domain name server.

42. The method (500) as claimed in claim 41, wherein the plurality of local servers (110′) further configured to have local domain name for connected spectators' portable devices (104) to access the local servers through browser.

43. The method (500) as claimed in claim 25, wherein the step of establishing (508) further comprises a step of connecting the plurality of local servers (110′) with a plurality of devices (114) to establish a Wi-Fi network or Wi-Fi mesh network at the venue.

44. The method (500) as claimed in claim 43, wherein the plurality of devices (114) is Wi-Fi router, Wi-Fi access points, Wireless mesh router, Wi-Fi mesh network devices, Wi-Fi extenders, Gateways and switches.

45. The method (500) as claimed in claim 43, wherein the step of connecting further comprises a step of establishing plurality of Wi-Fi access points throughout the venue and connecting spectators' portable devices (104) to form the wireless intranet network (116).

46. The method (500) as claimed in claim 25, wherein the step of connecting (510) further comprises a step of sharing SSID with or without access code by a plurality of devices (114) with the plurality of spectators' portable devices (104).

47. The method (500) as claimed in claim 25, wherein the plurality of spectators' portable devices (104) access and renders the plurality of live stream links automatically through captive portal while connecting with the wireless intranet network (116).

48. The method (500) as claimed in claim 25, wherein the plurality of spectators' portable devices (104) access and renders the plurality of live stream links through browsers by accessing system's local domain name or IP address.

49. The method (500) as claimed in claim 25, wherein the plurality of spectators' portable devices (104) access and renders the plurality of live stream links through custom client application.

50. The method (500) as claimed in claim 25, wherein the plurality of spectators' portable devices (104) renders all received plurality of live stream links in an embedded media player or on their default media player.

51. The method (500) as claimed in claim 25, further comprising a step of establishing internet access, by an internet module (118), to a system (100) employing the method (500) and enabling communication to cloud applications to manage the system activation or deactivation or subscriptions or licenses.

52. The method (500) as claimed in claim 51, further comprising a step of enabling communication, by the internet module (118), to plurality of cloud applications for authorizing the plurality of spectators' portable devices (104) to view plurality of live content (102) that is considered to be pay per view or paid or authorized view only or authorized through external payment gateway systems.

53. The method (500) as claimed in claim 51, further comprising a step of providing internet (120), by the internet module (118), to the connected plurality of spectators' portable devices (104).

54. The method (500) as claimed in claim 51, wherein the plurality of connected spectators' portable devices (104) enabled to receive different user interface options to change and render different streaming links from any of the plurality of live content (102) provided by the plurality of capturing means (106).
